(19) United States
(12) Patent Application Publication
(10) Pub. No.: US 2005/0165714 A1
(43) Pub. Date: Jul. 28, 2005

(54) Methods of use of ipmp data for mpeg-n ipmp (intellectual property management and protection)

(76) Inventors: Ming Ji, Singapore (SG); Sheng Mei Shen, Singapore (SG); Zhongyang Huang, Singapore (SG); Takanori Senoh, Osaka (JP)

Correspondence Address: GREENBLUM & BERNSTEIN, P.L.C., 1950 ROLAND CLARKE PLACE, RESTON, VA, 20191, US

(21) Appl. No.: 10/511,276

(22) PCT Filed: Apr. 24, 2003
(86) PCT No.: PCT/JP03/05248

(30) Foreign Application Priority Data
Apr. 26, 2002 (JP) NO. 2002-127121

(51) Int. Cl. G06F 7/00

(52) U.S. Cl. 707/1

(57) ABSTRACT

MPEG-n IPMP system with a wide interoperability is provided. For this purpose, the IPMP_Data_BaseClass is defined, several IPMP data extending from this base class are also defined. IPMP data is the data that describes IPMP information, it includes: IPMP_OpaqueData; IPMP_SelectiveDecryptionMessage; IPMP_AudioWatermarkingInit; IPMP_VideoWatermarkingInit; and IPMP_KeyData. Places where IPMP data extending from IPMP_Data_BaseClass are also specified. With the above work, a IPMP tool from Vendor A will be able to understand the IPMP data constructed by Content Author B, hence the inter-operability will be achieved, that is, the same protected content will be able to be consumed on different vendor's MPEG-n IPMP terminals.

### BACKGROUND OF THE INVENTION

1. Field of the Invention

The present invention relates to content distribution and protection, especially to such applications where the protected content based on MPEG-N is consumed by different IPMP terminals, and the same content is protected by different IPMP tools.

2. Description of the Background Art

Content distribution is becoming more and more demanding as multimedia data and contents can reach anywhere and anytime. Users are happy with the convenience and flexibility, and they can enjoy entertainment easily and efficiently. On the other hand, content owners are worried about the illegal usage of their property. There is a balance between two sides.

There are a lot of protection techniques for protecting the content, such as data encryption, watermarking, etc. They have been implemented in many content distribution applications. It seems different system employs different kinds of mechanisms and protection techniques to distribute content with protection. All the terminals or content consuming devices in that case are only able to play and consume the content that is provided by the same content provider. They cannot exchange their terminal or device to playback different contents.

In MPEG-n context, a standardisation group has been working on MPEG-2,4,7,21 IPMP. The solution is able to achieve both of the following:
1. Allow the same protected content to be consumed on different vendors' MPEG-n IPMP Terminals. This will be fully enabled; and
2. Allow the same content to be protected by different vendors' IPMP Tools.
   This will be assisted to as large extent as possible.

The prior art of MPEG-n IPMP is illustrated in FIG. 1.

To achieve such a wide interoperability, IPMP data needs to be standardized. IPMP data is the data that describes IPMP information, it may include time variant key that is carried in IPMP stream, it may also include tool initialisation information, or any data that an IPMP tool needs. However, so far, the standard of MPEG-2, 4, 7, 21 IPMP has not addressed this issue.

Without the standardization of IPMP data, a IPMP tool from Vendor A will not understand the IPMP data constructed by Content Author B, hence the inter-operability will not be achieved, that is, the same protected content will not be able to be consumed on different vendor's MPEG-n IPMP terminals.

### SUMMARY OF THE INVENTION

To solve the problem, to assure a clear and interoperable standard, the IPMP_Data_BaseClass is defined, several IPMP data extending from this base class are also defined, which include IPMP opaque data, audio watermarking tool initialisation information, video watermarking tool initialisation information, IPMP key stream, etc.

In a first aspect of the invention, a method of using IPMP Data in MPEG-2 IPMP system, at the content author side comprises the following steps of:
Constructing IPMP data extending from IPMP_Data_BaseClass, following the defined IPMP data syntax;
Carry the IPMP data in IPMP Descriptor in IPMP Control Graph which is subsequently carried in PSI.

In a second aspect of the invention, a method of using IPMP Data in MPEG-2 IPMP system, at the content author side comprises the following steps of:
Constructing IPMP data extending from IPMP_Data_BaseClass, following the defined IPMP data syntax;
Carry the IPMP data in IPMP Stream, the IPMP data is wrapped in Stream Data Update which has a destination address indicating which tool the IPMP data should be sent to.

In a third aspect of the invention, a method of using IPMP Data in MPEG-2 IPMP system, at the IPMP terminal side, comprises the following steps of:
The IPMP terminal extracts the IPMP Descriptor containing the IPMP data from the content stream;
The IPMP terminal delivers the IPMP Descriptor containing the IPMP data to the specific tool which is also indicated in IPMP Descriptor by the means of IPMP Tool ID;
The IPMP tool, upon receiving of such a IPMP Data, interprets it according to the specific IPMP data syntax, and act upon it.

In a fourth aspect of the invention, a method of using IPMP Data in MPEG-2 IPMP system, at the IPMP terminal side is proviede. The method comprises the following steps of:
The IPMP terminal demultiplexes the IPMP Stream containing the IPMP data from the content stream;
The IPMP terminal delivers each IPMP_StreamDataUpdate containing the IPMP data to the specific tool whose address is indicated in the above mentioned IPMP_StreamDataUpdate;
The IPMP tool, upon receiving of such an IPMP Data, interprets it according to the specific IPMP data syntax, and act upon it.

In a fifth aspect of the invention, a method of using IPMP Data in MPEG-4 IPMP system, at the content author side comprises the following steps of:

Constructing IPMP data extending from IPMP_Data_BaseClass, following the defined IPMP data syntax;
Carry the IPMP data in IPMP_Tool_Descriptor in OD stream.

In a sixth aspect of the invention, a method of using IPMP Data in MPEG-4 IPMP system, at the content author side, comprises the following steps of:

Constructing IPMP data extending from IPMP_Data_BaseClass, following the defined IPMP data syntax;
Carry the IPMP data in IPMP_Initialize which is subsequently carried in IPMP_Tool_Descriptor in OD stream.

In a seventh aspect of the invention, a method of using IPMP Data in MPEG-4 IPMP system, at the content author side, comprises the following steps of:
Constructing IPMP data extending from IPMP_Data_BaseClass, following the defined IPMP data syntax;
Carry the IPMP data in IPMP Stream, the IPMP data is wrapped in IPMP_StreamDataUpdate which has a destination address indicating which tool the IPMP data should be sent to.

In an eighth aspect of the invention, a method of using IPMP Data in MPEG-4 IPMP system, at the IPMP terminal side, comprises the following steps of:

The IPMP terminal extracts the IPMP_Tool_Descriptor containing the IPMP data from the content stream;
The IPMP terminal delivers the IPMP_Tool_Descriptor containing the IPMP data to the specific tool which is also indicated in IPMP_Tool_Descriptor by the means of IPMP Tool ID in IPMP_Tool_Descriptor;
The IPMP tool, upon receiving of such a IPMP Data, interprets it according to the specific IPMP data syntax, and act upon it.

In a ninth aspect of the invention, a method of using IPMP Data in MPEG-4 IPMP system, at the IPMP terminal side, comprises the following steps of:
The IPMP terminal extracts the IPMP_Initialize containing the IPMP data from the IPMP_Tool_Descriptor from the content stream;
The IPMP terminal delivers the IPMP_Tool_Descriptor containing the above mentioned IPMP_Initialize which subsequently carries IPMP data to the specific tool which is also indicated by the means of IPMP Tool ID in IPMP_Tool_Descriptor;
The IPMP tool, upon receiving of such an IPMP Data, interprets it according to the specific IPMP data syntax, and act upon it.

In a tenth aspect of the invention, a method of using IPMP Data in MPEG-4 IPMP system, at the IPMP terminal side, comprises the following steps of:
The IPMP terminal extracts the IPMP_StreamDataUpdate containing the IPMP data from the IPMP Stream from the content stream;
The IPMP terminal delivers the IPMP_StreamDataUpdate containing the above mentioned IPMP data to the specific tool which is also indicated in IPMP_StreamDataUpdate by the means of IPMP_ToolDescriptorID;
The IPMP tool, upon receiving of such an IPMP Data, interprets it according to the specific IPMP data syntax, and act upon it.

In an eleventh aspect of the invention, a method of using IPMP Data in MPEG-N IPMP system, at the content author side, comprises the following steps of:
Constructing IPMP data extending from some IPMP data base class, following the defined IPMP data syntax;
Carry the IPMP data in defined position in the MPEG-n IPMP content stream;
In a twelfth aspect of the invention, a method of using IPMP Data in MPEG-N IPMP system, at the IPMP terminal side, comprises the following steps of:
The IPMP terminal extracts the IPMP Data from the defined position in the content stream;
The IPMP terminal delivers the IPMP Data to the specific tool which is also indicated by the means of IPMP Tool ID associated with the IPMP Data;
The IPMP tool, upon receiving of such an IPMP Data, interprets it according to the specific IPMP data syntax, and act upon it.

In a thirteenth aspect of the invention, a Method of using IPMP video watermarking tool in MPEG-n IPMP system, at the IPMP terminal side, comprises the following steps of:
The IPMP terminal extracts the IPMP video watermarking initialization data from the defined position in the content stream;
The IPMP terminal delivers the IPMP video watermarking initialization data to the specific video watermarking tool which is also indicated by the means of IPMP Tool ID associated with the IPMP Data;
The IPMP video watermarking tool, upon receiving of such an IPMP Data, interprets it according to the specific IPMP data syntax, and act upon it;
The IPMP video watermarking tool, when detecting a watermark from the video stream, notifies the terminal using IPMP_SendVideoWatermark message.

### BRIEF DESCRIPTION OF THE DRAWINGS

This and other objects and features of the present invention will become clear from the subsequent description of a preferred embodiment thereof made with reference to the accompanying drawings, in which like parts are designated by like reference numerals and in which:

FIG. 1 is a diagram showing IPMP architecture for generic IPMP as the prior art;

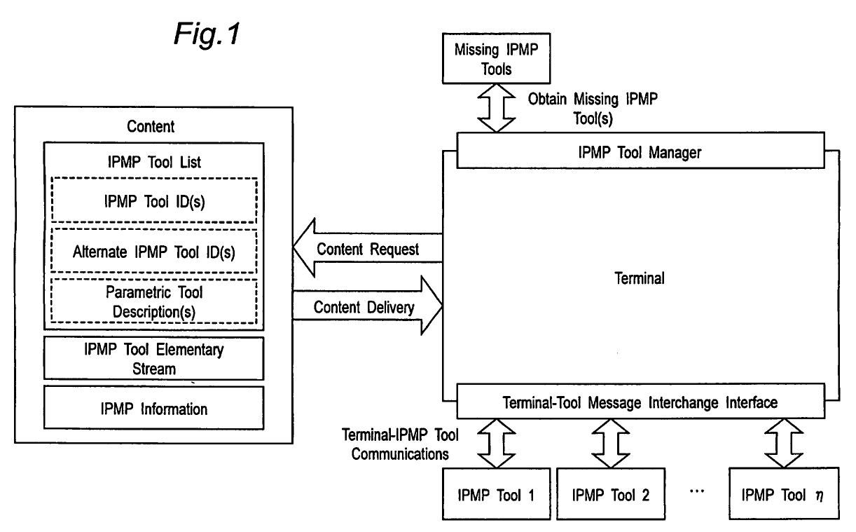

FIG. 2 is a diagram showing the types of IPMP data extending from IPMP_DataBase;

FIG. 3 is a diagram showing the places to carry IPMP data in MPEG-2 IPMP content; and

FIG. 4 is a diagram showing how MPEG-2 IPMP terminal processes IPMP protected MPEG-2 content using IPMP data.

### DETAILED DESCRIPTION OF THE PREFERRED EMBODIMENTS

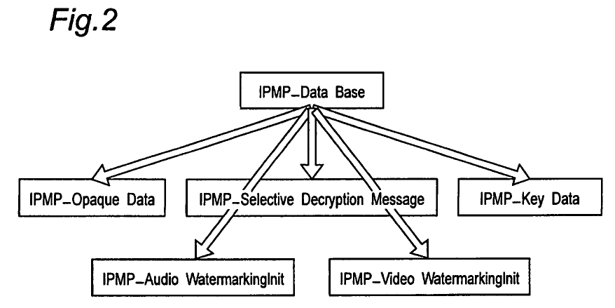

FIG. 2 illustrates the defined IPMP data extending from IPMP_Data_BaseClass. Places where IPMP data extending from IPMP_Data_BaseClass are also specified.

IPMP_DataBase defined as IPMP_Data_BaseClass includes information for using IPMP tool(s). The information is necessary to detect digital wartermarks and to decode content. Such information is managed in register of the IPMP system and is retrieved when processing the content.

IPMP_Data_BaseClass is described in predetermined syntax as shown in “Syntax” of “IPMP_Data_BaseClass” below. In order to achieve a flexible and interoperable IPMP system structure for MPEG-n and other applications as described above, we should be able to allow the followings.
1. Fix the syntax of various commonly used IPMP data, that includes:
   a. IPMP opaque data;
   b. IPMP decryption configuration data;
   c. IPMP audio watermarking configuration data;
   d. IPMP video watermarking configuration data; and
   e. IPMP key stream.
2. Fix the position of where the IPMP data should be carried in the MPEG-n content which is protected by IPMP.

Only when all above are fixed, the interoperable IPMP system for MPEG-n can be fully achieved.

Detailed explanations on items a to e will be described later.

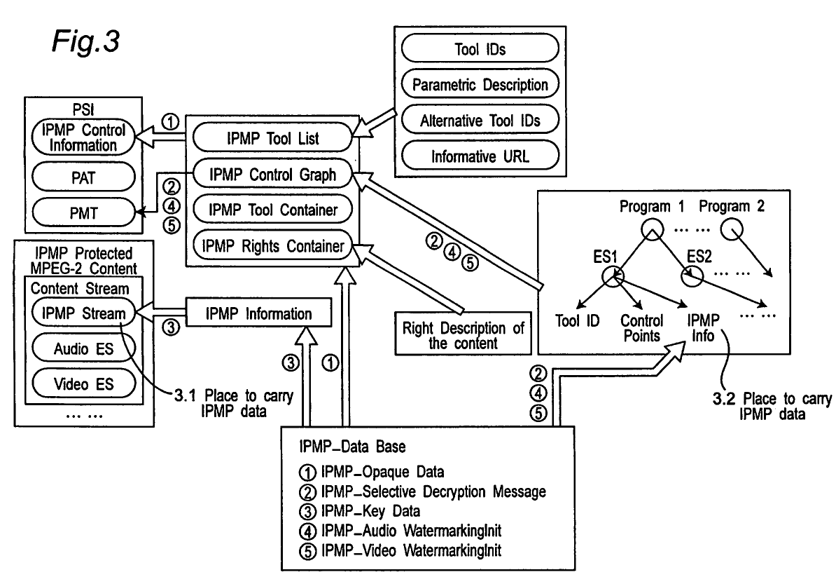

FIG. 3 illustrates the places to carry IPMP data in MPEG-2 IPMP conent. 3.1 is the place in IPMP stream, where IPMP data can be carried in IPMP_info_message which will then form the IPMP elementary stream. IPMP_KeyData can be carried in this place. 3.2 is the place in IPMP Descriptor which is subsequently carried in IPMP Control Graph Descriptor in PSI, tool initialisation data can be carried in this place.

IPMP Data is carried in the IPMP protected content bitstream (MPEG-2, 4, 7, 21). The base class is defined as IPMP_Data_BaseClass.

IPMP data that are all extended from IPMP_Data_BaseClass include:
the IPMP_AudioWatermarkingInit;
IPMP_SelectiveDecryptionMessage;
IPMP_VideoWatermarkingInit;
IPMP_KeyData; and

IPMP_OpaqueData.

```
IPMP_Data_BaseClass
Syntax
Aligned(8) expandable(2²⁸−1)class IPMP_Data_BaseClass{
  bit(8) Version;
  bit(8) IPMP_DataTag;
}
```

Semantics

Version indicates the version of syntax used in the IPMP Data and shall be set to 0x01.

IPMP_DataTag indicates the tag for the extended IPMP data. The exact values for the extension tags are defined in the following table.

TABLE 1
Tags for messages extending IPMP_ToolMessageBase

| 8-bit Tag Value | Symbolic Name |
|---|---|
| 0x00 | Forbidden |
| 0x01 | IPMP_OpaqueData_tag |
| 0x02 | IPMP_SelectiveDecryptionMessage_tag |
| 0x03 | IPMP_AudioWatermarkingInit_tag |
| 0x04 | IPMP_VideoWatermarkingInit_tag |
| 0x05 | IPMP_KeyData_tag |
| | <-> IPMP_RightsData_tag |
| 0x06-0xCF | ISO Reserved |
| 0xD0-0xFE | User Defined |
| 0xFF | Forbidden |

Places to carry IPMP Data extended from IPMP_Data_BaseClass
IPMP Data extending from IPMP_Data_BaseClass could be carried in the following two places:
IPMP_Descriptor class (MPEG-2 system)
—IPMP_info_message class which is subsequently carried in IPMP Stream. (MPEG-2 system)
IPMP_Tool_Descriptor class (MPEG-4 system)
IPMP_Initialize which is subsequently carried in IPMP_Tool_Descriptor class (MPEG-4 system)
IPMP_StreamDataUpdate which is subsequently carried in IPMP Stream. (MPEG-4 system).

In MPEG-2 system case, the IPMP_Descriptor and IPMP_info_message need modifications as below:

IPMP_Descriptor

The new syntax for this should be:

TABLE 2
IPMP Descriptor

| Syntax | No. of bits | Mnemonic |
|---|---|---|
| 0 IPMP_descriptor( ) { | | |
| descriptor_tag | 8 | Uimsbf |
| descriptor_length | 8 | Uimsbf |
| IPMP_DescriptorID | 8 | Uimsbf |
| IPMP_ToolID | 128 | Uimsbf |
| numControlPoints | 8 | uimsbf |
| for ( i=0; i<numControlPoints; | | |
| i++) { | | |
| controlPoint | 8 | uimsbf |
| sequenceCode | 8 | uimsbf |
| IPMP_Data_length | 16 | uimsbf |
| for ( i=0; i< N; | | |
| i++) { | | |
| IPMP_Data | | |
| } | | |
| } | | |
| } | | |

where the IPMP_Data is the IPMP Data extended from IPMP_Data_BaseClass.
IPMP_StreamDataUpdate

The IPMP Stream should be a concatenation of IPMP Stream Data Update, with the new syntax defined below.

TABLE 3
IPMP_StreamDataUpdate

| Syntax | No. of bits | Mnemonic |
|---|---|---|
| IPMP_info_message( ) { | | |
| IPMP_descriptor_id | 8 | uimsbf |
| control_point | 8 | uimsbf |
| length_of_message | 16 | uimsbf |
| IPMP_Data_length | 16 | uimsbf |
| for ( i=0; i<N; i++) { | | |
| IPMP_data | 8 | uimsbf |
| } | | |
| } | | |

where the IPMP_Data is the IPMP Data extended from IPMP_Data_BaseClass.

IPMP_StreamDataUpdate has a destination address indicating which tool the IPMP data should be sent to.

Types of IPMP Data that extends from IPMP_Data_BaseClass

Opaque Data

Opaque Data can contain various infromation depending on respective users, cases and so on.

There are many cases where opaque data may be needed for certain tools. Hence IPMP_OpaqueData tag=0x01 is reserved for carriage of opaque data. The syntax is illustrated below.

class IPMP_OpaqueData extends IPMP_Data_BaseClass
: bit(8) tag = IPMP_OpaqueData_tag
{
ByteArray opaqueData;
}

Selective Decryption Configuration Message

Selective Decryption Configuration Message specifies portions in the IPMP Stream, where the stream is encrypted.

The class IPMP_SelectiveDecryptionMessage should now be extended from IPMP_Data_BaseClass instead of IPMP_ToolMessageBase. The tag for this class should be IPMP_SelectiveDecryptionMessage_Tag as defined in the above table for IPMP_Data_BaseClass tags.

Audio Watermarking Configuration Message

Audio Watermarking Configuration Message specifies an initial value to detect watermarks added on an audio stream.

The class IPMP_AudioWatermarkingInit should now be extended from IPMP_Data_BaseClass instead of IPMP_ToolMessageBase. The tag for this class should be IPMP_AudioWatermarkingInit_Tag as defined in the above table for IPMP_Data_BaseClass tags.

See “MPEG-2 IPMP”, ISO/IEC 13818-1:2000 PDAM2, March, 2002, and “MPEG 4 IPMP Extension”, FPDAM ISO/IEC 14496-1:2001/AMD3, March, 2002.

IPMP Key Data

The IPMP_KeyData is defined to extend from IPMP_Data_BaseClass. This IPMP data could possibly be carried in IPMP_info_message which is subsequently carried in IPMP Stream. This facilitates the time variant key carried in IPMP Stream.

```
Syntax
class IPMP_KeyData extends IPMP_Data_BaseClass :
  bit(8) tag = IPMP_KeyData_tag
{
  ByteArray keyBody;
  bit(1) isTimeScheduled;
  const bit(7) reserved = 0b000000;
  if (isTimeScheduled)
  {
    bit(33) PTS;
    const bit(7) reserved = 0b000000;
  }
  ByteArray OpaqueData;
}
```

Semantics

keyBody—the body of the key. The value shall be data that conforms to a rule for data structure of the key defined outside of this document.

IsTimeScheduled—Specify if the key is scheduled to be active at a certain PTS value. If this value is set to 1, there should be a PTS value followed indicating the activation time.

OpaqueData—Any other opaque data carried in this IPMP data.

Video Watermarking Configuration Message

Video Watermarking Configuration Message specifies an initial value to detect watermarks added on a video stream. IPMP_VideoWatermarkingInit data is used to intialise a Watermarking Tool about the process of insertion/extraction of the watermarking payload into/from a video stream.

```
Syntax
class IPMP_VideoWatermarkingInit extends IPMP_Data_BaseClass :
  bit(8) tag = IPMP_VideoWatermarkingInit_tag
{
  bit(8) inputFormat;
  bit(4) requiredOp;
  bit(1) hasOpaqueData;
  const bit(3) reserved = 0b000;
  if (inputFormat == YUV)
  {
    bit(16) frame_horizontal_size;
    bit(16) frame_vertical_size;
    bit(8) chroma_format;
  }
  if ((requiredOp == INSERT_WM)∥(requiredOp == REMARK_WM))
  {
    bit(16) wmPayloadLen;
    bit(8) wmPayload[wmPayloadLen];
  }
  if ((requiredOp == EXTRACT_WM))
  {
    bit(16) wmRecipientId;
  }
  if (hasOpaqueData)
  {
    bit(16) opaqueDataSize;
    bit(8) opaqueData[opaqueDataSize];
  }
}
```

Semantics

The IPMP_videoWatermarkingInit data delivers to a watermarking tool all the information about the characteristics of the video content, the type of action to be performed on it and, possibly other related proprietary data required by the watermarking tool. Furthermore in case of:
insertion, the watermarking payload to be inserted;
extraction, the ID of the recipient of the watermarking payload is provided;
remarking, the watermarking payload to be inserted.
inputFormat: The format of the video input stream, as indicated in a Table to be maintained by a registration authority. The Table shall contain at least all video formats indicated in Table 8 “ObjectTypeIndication values” in [3]
RequiredOp: The operation that the watermarking tool is required to perform on the audio stream. The following values are allowed:INSERT_WM=0EXTRACT_WM=1REMARK_WM=2ISO reserved=3 . . . 10User defined=11 . . . 15
frame_horizontal_size: Horizontal size of the yuv frame
frame_vertical_size: vertical size of the yuv frame
chroma_format: chroma_format: 0x01=4:2:0, 0x02=4:2:2, 0x03=4:4:4, ISO reserved=0x04 . . . 0xA0, User defined=0xA1 . . . 0xFE, Forbidden: 0x00, 0xFF
WmPayloadLen: the length of the watermarking payload in bytes to be inserted in the video content.
WmPayload: the watermarking payload to be inserted in the video content
WmRecipientId: the address of the destination tool, to which the watermarking payload and compression information must be delivered.
HasOpaqueData: a flag that indicates if the message also carries opaque data information for the watermarking tool.
OpaqueDataSize: the length of the opaque data field in bytes
OpaqueData: the opaque data field carrying proprietary information to the watermarking tool (e.g. initialisation parameters, like specific algorithm id, keys, etc.)
   IPMP_SendVideoWatermark Message

The Watermarking Tool receives the video stream and in case of watermarking extraction, replies with an IPMP_SendVideoWatermark message carrying the watermarking payload.

```
Syntax
class IPMP_SendVideoWatermark extends IPMP_ToolMessageBase :
  bit(8) tag = IPMP_SendVideoWatermark_tag
{
  bit(4) wm_status;
  bit(1) hasOpaqueData;
  bit(3) reserved = 0b000;
  if (wm_status == WM_PAYLOAD)
  {
    ByteArray payload;
  }
  if (hasOpaqueData)
  {
    ByteArray opaqueData;
  }
}
```

Semantics

A watermarking tool, which has been required to perform payload extraction by means of an IPMP_VideoWatermarkingInit will send this message to wmRecipientId each time a new watermarking payload is extracted from the videocontent.
wm_status: the result of the check if watermarking was present. If watermark was detected, then this value also says if the payload extracted is carried inside the message or not. Possible values are listed in the wm_status table below.
hasOpaqueData: a flag indicating whether this message carries opaque data.
payload: the watermarking payload extracted from the video content.
opaqueData: opaque data from the Watermarking Tool.
   wm_status Table
WM_PAYLOAD: Watermarking was present in the video stream, payload is carried in the message.
WM_NOPAYLOAD: Watermarking was present in the video stream, no payload is carried in the message.
NO_WM: Watermarking was not present in the video stream.
WM_UNKNOWN: The Watermarking Tool was unable to detect whether watermarking was present in the video stream or not.

Refering now to FIG. 3, adaptation of the information contained in IPMP_DataBase is described next. FIG. 3 shows flows of information in a server which provides a terminal with a IPMP protected content. In this Figure, Program Specific Information (“PSI”) and “IPMP Protected MPEG-2 Content” are finally obtained and provided for the terminal. PSI describes, for example, one or more types of scrambling scheme and existence of wartermarks. One PSI may be created for each content, or for a plurality of content.

IPMP_OpaqueData is set in IPMP Control Information in PSI.

The three types of information “IPMP_SelectiveDecryptionMessage”, “IPMP_AudioWatermarkingInit”, and “IPMP_VideoWatermarkingInit” are defined in IPMP_Info, where IPMP data is carried. The above three types of information are incorporated in IPMP_Control_Graph and then set in Program Map Table (PMT).

“IPMP_KeyData” forms a part of IPMP information, which contains data on one or more keys for descrambling the content. “IPMP_KeyData” may be varied dependent on time. A headeer is added to IPMP information to be incorporated in “IPMP Stream” in the Content Stream, where IPMP data is carried.

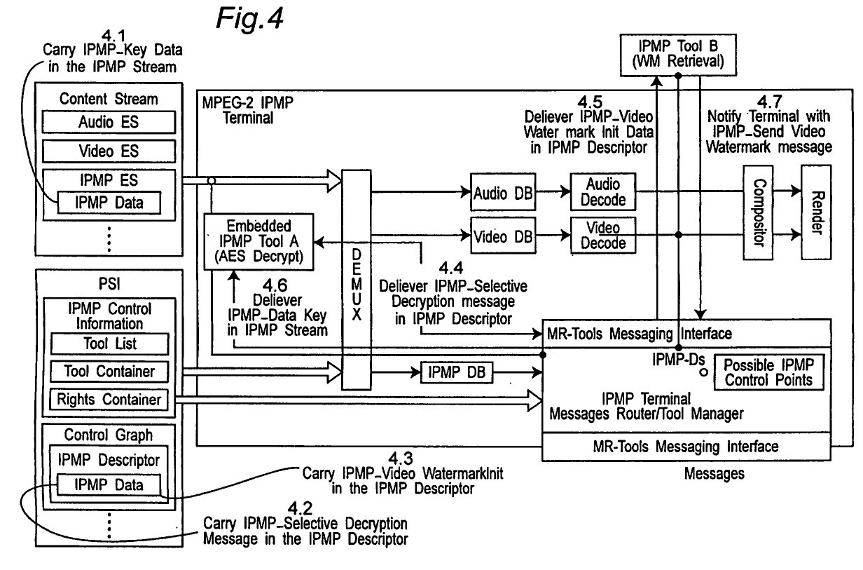

Based on the IPMP_Data_BaseClass, some useful IPMP data syntax were clearly defined. Suppose the content's video stream is encrypted by IPMP AES tool A, the content author can dearly define an AES tool initialisation information using IPMP_SelectiveDecryptionMessage extending from IPMP_Data_BaseClass. The initialization information may include block size, encryption method. The entire IPMP_SelectiveDecryptionMessage can be carried in IPMP Descriptor (in MPEG-2 IPMP case) or IPMP_Tool_Descriptor (in MPEG4 IPMP case), as illustrated by 4.1 in FIG. 4.

The video stream may be encrypted by a time variant key stream. In this case, the content author constructs IPMP_KeyData extending from IPMP_Data_BaseClass which includes the time variant key. The IPMP_KeyData is carried in IPMP Stream, as illustrated by 4.2 in FIG. 4.

The AES tool vendor can then conform to the same standard, and develop a AES Decryption tool A (as illustrated in FIG. 4) that can understand the IPMP_SelectiveDecryptionMessage coming from IPMP_Descriptor or IPMP_Tool_Descriptor in the content stream.

Suppose the content's video stream is watermarked by IPMP Video Watermarking tool B, the content author can clearly define a video watermarking tool initialisation information using IPMP_VideoWatermarkingInit extending from IPMP_Data_BaseClass. The initialization information may include chroma format, frame size, watermark payload to be inserted, whether to insert or extract watermark, etc. The entire IPMP_VideoWatermarkingInit can be carried in IPMP Descriptor (in MPEG-2 IPMP case) or IPMP_Tool_Descriptor (in MPEG-4 IPMP case), as illustrated by 4.3 in FIG. 4.

The video watermarking tool vendor can then conform to the same standard, and develop a video watermark tool B (as illustrated in FIG. 4) that can understand the IPMP_VideoWatermarkingInit coming from IPMP_Descriptor or IPMP_Tool_Descriptor in the content stream.

At the terminal side, when the terminal receives the content stream, it retrieves the IPMP Descriptor from IPMP Control Graph in MPEG-2's PSI. The IPMP Descriptor containing the IPMP_SelectiveDecryptionMessage is delievered to the AES decryption tool A as illustrated by 4.4 in FIG. 4. AES decryption tool receives this IPMP data, parses it according to the defined syntax, and configures itself.

The IPMP Descriptor containing the IPMP_VideoWatermarkingInit is delievered to the video watermarking tool B as illustrated by 4.5 in FIG. 4. Video watermarking tool B receives this IPMP data, parses it according to the defined syntax, and configures itself.

When the content flows it, the MPEG-2 terminal's demultiplexer retrieves IPMP data which contains the time variant key from IPMP stream. It delivers this IPMP Data to AES decryption tool A as illustrated by 4.6 in FIG. 4. Tool A receives this IPMP_KeyData, and uses the new time variant key to decrypt the video elementary stream.

The video watermarking tool receives the video stream and in case of watermarking extraction, replies with an IPMP_SendVideoWatermark message carrying the watermarking payload as illustrated by 4.7 in FIG. 4.

With the above mentioned embodiment, by constructing a data base which contains information to be used to inform the MPEG-2 IPMP terminal what kind of content protection tool is used, what kind of watermarking tool is used, or what kind of encryption key is used, the interoperability between the protected-content provided and this receiver can be realized and any MPEG-n IPMP terminal can decrypt the contents sent from a content provider together with the IPMP stream or IPMP control information or IPMP control graph.

1. A method of using IPMP Data in IPMP system, at the content author side, comprising:
Constructing a database which contains information to be used for IPMP tool required to process and protect content;
Creating an IPMP data from the information contained in the database;
Adding the IPMP data to the content to creat IPMP protected content.

2. The Method of using IPMP Data in IPMP system according to claim 1, at the content author side,
wherein the IPMP data is constructed by extracting information from the database based on a defined IPMP data syntax.

3. The Method of using IPMP Data in IPMP system according to claim 2, at the content author side, further comprising carrying the IPMP data in IPMP Descriptor in IPMP Control Graph, which is subsequently carried in PSI.

4. The Method of using IPMP Data in IPMP system according to claim 2, at the content author side, wherein the IPMP data is wrapped in IPMP_StreamDataUpdate which has a destination address indicating which tool the IPMP data should be sent to.

5. The Method of using IPMP Data in IPMP system according to claim 1, wherein the IPMP Protected content is MPEG-2 content.

6. The Method of using IPMP Data in IPMP system according to claim 2,
wherein the IPMP Protected content is MPEG-4 content, and
wherein the method further comprises Carrying the IPMP data in IPMP_Tool_Descriptor in OD stream.

7. The Method of using IPMP Data in IPMP system according to claim 2,
wherein the IPMP Protected content is MPEG4 content, and
wherein the method further comprises Carrying the IPMP data in IPMP_Initialize which is subsequently carried in IPMP_Tool_Descriptor in OD stream.

8. The Method of using IPMP Data in IPMP system according to claim 2,
wherein the IPMP Protected content is MPEG-4 content, and
wherein the method further comprises Carrying the IPMP data in IPMP Stream, which is wrapped in IPMP_StreamDataUpdate which has a destination address indicating which tool the IPMP data should be sent to.

9. The Method of using IPMP Data in IPMP system according to claim 2,
wherein the IPMP Protected content is MPEG-n content, and
wherein the method further comprises Carrying the IPMP data in defined position in the MPEG-n IPMP content stream.

10. A Method of using IPMP Data in IPMP system, at the IPMP terminal side, comprising:
Extracting IPMP Descriptor containing IPMP data from IPMP Protected content; and
Delivering IPMP Descriptor containing the IPMP data to a IPMP tool which is also indicated in IPMP Descriptor by the means of IPMP Tool ID,
wherein the IPMP tool, upon receiving of such a IPMP Data, interprets it according to the specific IPMP data syntax, and act upon it.

11. A Method of using IPMP Data in IPMP system, at the IPMP terminal side, according to claim 10, further comprising:
Demultiplexing the IPMP Stream containing the IPMP data from the IPMP Protected content; and
Delivering each IPMP_StreamDataUpdate containing the IPMP data to the IPMP tool whose address is indicated in the above mentioned IPMP_StreamDataUpdate,
wherein the IPMP tool, upon receiving of such an IPMP Data, interprets it according to the specific IPMP data syntax, and act upon it.

12. A Method of using IPMP Data in IPMP system, at the IPMP terminal side, according to claim 10, wherein the IPMP Protected content is MPEG-2 content.

13. A Method of using IPMP Data in IPMP system, at the IPMP terminal side, according to claim 12, further comprising:
Extracts the IPMP_Tool_Descriptor containing the IPMP data from the IPMP Protected content; and
Delivering the IPMP_Tool_Descriptor containing the IPMP data to the IPMP tool which is also indicated in IPMP_Tool_Descriptor by the means of IPMP Tool ID in IPMP_Tool_Descriptor,
wherein the IPMP tool, upon receiving of such a IPMP Data, interprets it according to the specific IPMP data syntax, and act upon it.

14. A Method of using IPMP Data in IPMP system, at the IPMP terminal side, according to claim 10,
wherein the IPMP Protected content is MPEG-4 content,
wherein the method further comprises:
Extracts the IPMP_Initialize containing the IPMP data from the IPMP_Tool_Descriptor from the IPMP Protected content;
Delivering the IPMP_Tool_Descriptor containing the above mentioned IPMP_Initialize which subsequently carries IPMP data to the IPMP tool which is also indicated by the means of IPMP Tool ID in IPMP_Tool_Descriptor,
wherein the IPMP tool, upon receiving of such an IPMP Data, interprets it according to the specific IPMP data syntax, and act upon it.

15. A Method of using IPMP Data in IPMP system, at the IPMP terminal side, according to claim 10,
wherein the IPMP Protected content is MPEG4 content,
wherein the method further comprises:
Extracts the IPMP_StreamDataUpdate containing the IPMP data from the IPMP Stream from the IPMP Protected content;
Delivering the IPMP_StreamDataUpdate containing the above mentioned IPMP data to the specific tool which is also indicated in IPMP_StreamDataUpdate by the means of IPMP_ToolDescriptorID, and
wherein the IPMP tool, upon receiving of such an IPMP Data, interprets it according to the specific IPMP data syntax, and act upon it.

16. A Method of using IPMP Data in IPMP system, at the IPMP terminal side, according to claim 10,
wherein the IPMP Protected content is MPEG-n content,
wherein the method further comprises:
Extracting the IPMP Data from the defined position in the IPMP Protected content; and
Delivering the IPMP Data to the IPMP tool which is also indicated by the means of IPMP Tool ID associated with the IPMP Data,
wherein the IPMP tool, upon receiving of such an IPMP Data, interprets it according to the specific IPMP data syntax, and act upon it.

17. A Method of using IPMP Data in IPMP system, at the IPMP terminal side, according to claim 10,
wherein the IPMP Protected content is MPEG-n content,
wherein the method further comprises:
Extracting the IPMP video watermarking initialization data from the defined position in the IPMP Protected content; and
Delivering the IPMP video watermarking initialization data to the specific video watermarking tool which is also indicated by the means of IPMP Tool ID associated with the IPMP Data,
wherein the IPMP video watermarking tool, upon receiving of such an IPMP Data, interprets it according to the specific IPMP data syntax, and act upon it, and
wherein the IPMP video watermarking tool, when detecting a watermark from the video stream, notifies the terminal using IPMP_SendVideoWatermark message.
